(19) United States
(12) Patent Application Publication
(10) Pub. No.: US 2004/0034938 A1
(43) Pub. Date: Feb. 26, 2004

(54) Method for treating textile fibre materials or leather

(76) Inventors: Hauke Rohwer, Lorrach (DE); Mario Dubini, Niederdorf (CH); Petr Kvita, Reinach (CH); Rolf Kuratli, Basel (CH)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/312,550

(22) PCT Filed: Jun. 26, 2001
(86) PCT No.: PCT/EP01/07266

(30) Foreign Application Priority Data
Jul. 4, 2000 (EP) 00810581.9

(51) Int. Cl. C14C 1/00

(52) U.S. Cl. 8/94.15

(57) ABSTRACT

The present invention relates to a method for reducing dye loss or dye transfer from textile fibre materials or leather in the domestic sector, which comprises treating the textile fibre materials or the leather with a dye-fixing agent based on basic polycondensation products of an amine of formula (1) and a cyanamide, which polycondensation products are completely or partially neutaalised with an inorganic or organic acid, R₁, R₂, R₃ and R₄ each independently of the others being hydrogen or alkyl that is unsubstituted or substituted by amino, hydroxy, cyano or by C₁-C₄ alkoxy and A being alkylene optionally substituted or interrupted by one or more hereto atoms. The present invention relates also to new formulations comprising the dye-fixing agent and to new dye-fixing agents.

The present invention relates to a method for reducing dye loss or dye transfer from textile fibre materials or leather in the domestic sector and also to formulations and dye-fixing agents used in that method.

In conventional domestic washing methods, the loss of dye when coloured textiles are washed is a known problem. A further problem in that context is the transfer of dye when coloured textiles are washed together with white, or coloured, textiles, especially white or light-coloured textiles. Similar problems exist for coloured leather materials.

The aim of the present invention is to provide an improved method, suitable for the domestic sector, by which the dye loss and dye transfer can be further reduced.

EP-A-692 511 discloses a method according to which fibre materials are dyed on an industrial scale and then treated with the basic polycondensation product mentioned hereinbelow, the polycondensation product not, however, having been neutralised with an acid. It has now been found, surprisingly, that the stated aim can largely be achieved using specific basic polycondensation products that are completely or partially neutralised with an inorganic or organic acid.

The present invention accordingly relates to a method for reducing dye loss or dye transfer from textile fibre materials or leather in the domestic sector, which comprises treating the textile fibre materials or the leather with a dye-fixing agent based on basic polycondensation products of an amine of formula

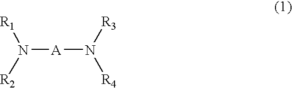

and a cyanamide, which polycondensation products are completely or partially neutralised with an inorganic or organic acid,

R₁, R₂, R₃ and R₄ each independently of the others being hydrogen or alkyl that is unsubstituted or substituted by amino, hydroxy, cyano or by C₁-C₄alkoxy and A being alkylene optionally substituted or interrupted by one or more hetero atoms.

A in formula (1) is preferably C₂-C₂₀alkylene optionally interrupted by —O—, —S—, —NH— or by —N(C₁-C₄alkyl)- and/or substituted by hydroxy, especially C₂-C₂₀alkylene interrupted one or more times by —NH—.

R₁, R₂, R₃ and R₄ preferably are each independently of the others hydrogen or C₁-C₄alkyl.

Examples of suitable compounds of formula (1) are 1,4-butanediamine, 1,6-hexanediamine, dipropylenetriamine, N-(2-aminoethyl)-1,3-propanediamine, N,N-bis(2-aminopropyl)methyl-amine, polyethyleneimines and polyethylenepolyamines such as diethylenetriamine, triethylenetetramine, tetraethylenepentamine and pentamethylenehexamine. Preferred compounds of formula (1) are polyethylenepolyamines and, among those, especially diethylenetriamine. The number of repeating units of monomers of formula (1) in the basic polycondensation products is, for example, from 4 to 100, especially from 4 to 50.

Suitable cyanamides are, for example, cyanamide, dicyandiamide, guanidine and biguanidine. Preference is given to dicyandiamide.

The above-mentioned dye-fixing agents are known, for example, from EP-A-692 511 and can be obtained by the method disclosed therein.

For example, an amine of formula (1) is reacted with an ammonium salt in the presence of a non-aqueous solvent and the protonated product obtained is reacted with a cyanamide at elevated temperature.

Suitable ammonium salts are, for example, ammonium salts of organic or inorganic acids, 7for example ammonium chloride, ammonium sulfate, ammonium carbonate, ammonium formate and ammonium acetate, especially ammonium chloride.

Suitable non-aqueous solvents are, for example, hydroxyl-group-containing solvents, e.g. ethylene glycol, 1,2- or 1,3-propylene glycol, butylene glycol, di-, tri- or tetra-ethylene glycol and ethers thereof, and polyethylene glycols having a molecular weight of, for example, from 600 to 5000, and mixtures thereof.

The amine of formula (1) and the ammonium salt are used in a molar ratio of, for example, from 1:0.1 to 1:2.5, preferably from 1:0.7 to 1:2. The amount of hydroxyl-group-containing solvent can vary within wide limits and is, for example, from 0.2 to 20 mol, and preferably from 0.4 to 5 mol, per mol of compound of formula (1).

The reaction of the amine of formula (1) with the ammonium salt is carried out especially at elevated temperature, for example from 80 to 200° C., especially from 100 to 160° C. For example, the amine of formula (1) is introduced into the hydroxyl-group-containing solvent or solvent mixture and the ammonium compound is metered in; the reaction step is advantageously carried out under inert conditions, for example under a nitrogen atmosphere.

The protonated product obtained is then reacted with, for example, from 0.5 to 2 mol, and preferably from 0.8 to 1.5 mol, of cyanamide per mol of starting compound of formula (1). That reaction is carried out, for example, in the presence of one or more of the above-mentioned hydroxyl-group-containing solvents at elevated temperature, for example from 80 to 250° C. and especially from 140 to 220° C. At room temperature, the reaction products are generally solid melts having basic properties, which yield clear solutions in water.

Neutralisation with an inorganic or organic acid is carried out, for example, in an aqueous medium, the addition of acid being so carried out that the pH is adjusted to, for example, from 2 to 12, preferably from 3 to 10 and especially from 4 to 8. Special preference is given to an amount of acid by means of which the pH is adjusted to about 7.

Suitable inorganic or organic acids are, for example, mono- or poly-carboxylic acids, hydrochloric acid, phosphoric acid, sulfuric acid or a mixture of at least two such acids. Preference is given to organic acids. Examples of organic acids that may be mentioned are oxalic acid, tartaric acid, acetic acid, propionic acid, succinic acid, maleic acid, citric acid, formic acid, gluconic acid, p-toluenesulfonic acid, terephthalic acid, benzoic acid, phthalic acid, acrylic acid and polyacrylic acid. Of special interest are aliphatic carboxylic acids, especially those having a total of from 1 to 12 carbon atoms. Preferred acids are aliphatic C₁-C₁₂-mono- or -poly-carboxylic acids, the monocarboxylic acids being especially those having a total of at least 3 carbon atoms. Suitable subsfituents of the carboxylic acids are, for example, hydroxy and amino, especially hydroxy. Also of interest are mixtures of the said acids; for exampl, the mixture of maleic acid and propionic acid may be mentioned.

Special preference is given to aliphatic C₂-C₁₂polycarboxylic acids, especially aliphatic C₂-C₆polycarboxylic acids. Very special preference is given to hydroxy-substituted aliphatic C₂-C₆polycarboxylic acids.

The dye-fixing agents are generally used in liquid aqueous form. For neutralisation of the basic polycondensation products, therefore, it is possible to proceed, for example, by first preparing a relatively concentrated, liquid aqueous composition. For that purpose, the basic polycondensation product, the acid, water and, optionally, a water-miscible organic solvent can be mixed together. Preference is given to the use of from 0.1 to 70% by weight, especially from 0.5 to 70% by weight and preferably from 1 to 60% by weight, of dye-fixing agent, based on the total weight of the solution. Special preference is given to the use of from 5 to 50% by weight, especially from 15 to 50% by weight, of the dye-fixing agent. The amount of acid is so selected that the pH of the solution is adjusted to, for example, from 2 to 12, preferably from 3 to 10 and especially from 4 to 8. Special preference is given to an amount of acid by means of which the pH is adjusted to about 7. Suitable water-miscible organic solvents are, for example, appropriate hydroxy-group-containing solvents, such as methanol or ethanol, and also ether. Preference is given to preparation of the solution without organic solvents.

In addition, such concentrated solutions may also comprise further customary additives such as perfume oils, foam-regulating agents, thickeners, microbicidal agents, complexing agents, UV absorbers and, especially, bleaching agents.

The solutions of completely or partially neutralised basic polycondensation products are preferably clear, storage-stable solutions.

The concentrated solutions can be used directly or further treated before application.

Examples of further treatment are further dilution, especially with water, and incorporation into a washing composition or fabric softener composition. In addition, there may be mentioned spray-drying, granulation, micro-encapsulation, application to solid carrier materials (e.g. to particles of solids, such as zeolite or silica gel, or application to textiles that are added during the washing procedure or pre- or post-wash).

Preference is given to application from an aqueous bath. Such application is preferably carried out as part of the washing procedure for the said materials, especially the textile fibre materials. The treatment can be carried out before the washing procedure, during or, especially, after the washing procedure.

For example, before the washing procedure the textile fibre materials can be pre-treated in an aqueous bath with the dye-fixing agent. Such pre-treatment can be carried out, for example, in a separate bath or alternatively in the washing machine. Advantageous temperatures for that treatment are, for example, in the range from 5 to 80° C., preferably from 10 to 60° C. and especially from 10 to 40° C. The concentration of fixing agent in the bath is, for example, in the range from 0.01 to 20 g/litre, preferably from 0.05 to 10 g/litre and especially from 0.1 to 5 g/litre.

Moreover, during the washing procedure the textile fibre materials can be treated in an aqueous bath with the dye-fixing agent and a washing composition, or a washing composition comprising the dye-fixing agent; that treatment is generally carried out in the washing machine. Advantageous temperatures for that treatment are, for example, in the range from 5 to 100° C., preferably from 10 to 80° C. and especially from 20 to 60° C. The concentration of fixing agent in the bath is, for example, in the range from 0.01 to 20 g/litre, preferably from 0.05 to 10 g/litre and especially from 0.1 to 5 g/litre.

Furthermore, after the washing procedure the textile fibre material can be treated in an aqueous bath with the dye-fixing agent and a fabric softener composition, or a fabric softener composition comprising the dye-fixing agent. Alternatively, that treatment can also be carried out without a fabric softener composition being present. Advantageous temperatures for those treatments are, for example, in the range from 5 to 80° C., preferably from 10 to 60° C. and especially from 10 to 40° C. The concentration of fixing agent in the bath is in the range, for example, from 0.01 to 20 g/litre, preferably from 0.05 to 10 g/litre and especially from 0.1 to 5 g/litre.

Suitable washing compositions and fabric softener compositions are commercially available washing compositions and fabric softener compositions in solid or liquid form.

Mention may be made of the following as conventional components of washing compositions: builders (e.g. zeolites/layer silicates), polymers (co-builders), bleaching agents and bleaching systems (e.g. perborate/percarbonate plus TAED), fluorescent whitening agents, greying inhibitors, enzymes, fragrances and/or colorants, surfactants of the alkyl benzenesulfonate (LAS) type, fatty alcohol sulfates, soaps and fatty alcohol ethoxylates. Furthermore, polycarboxylates (polyacrylic acids) can be used for improving the wash result and the calcium-complexing capability, and foam inhibitors (silicone/paraffin compounds) can be used for reducing foam.

Mention may be made of the following as conventional components of fabric softener compositions: alcohols, e.g. ethanol, n-propanol, isopropanol, polyhydric alcohols, e.g. glycerol and propylene glycol; amphoteric and non-ionic surfactants, e.g. carboxyl derivatives of imidazole, ethoxylated fatty alcohols, hydrogenated and ethoxylated castor oil, alkyl polyglycosides, for example decyl polyglucose and dodecyl polyglucose, fatty alcohols, fatty acid esters, fatty acids, ethoxylated fatty acid glycerides or fatty acid partial glycerides; also, relatively small amounts of colorants, perfumes, buffer substances, inorganic or organic salts, e.g. water-soluble potassium, sodium or magnesium salts, non-aqueous solvents, pH buffers, perfumes, colorants, hydrotropic agents, antifoams, corrosion inhibitors, anti-redeposition agents, viscosity-regulators, especially polymeric or other thickeners, stabilisers, enzymes, fluorescent whitening agents, anti-shrinkage agents, anti-stain agents, antimicrobial agents, germicides, fungicides, antioxidants, corrosion inhibitors and anti-creasing agents.

If the fixing agent is a constituent of the washing composition or fabric softener composition, the content of fixing agent is in the range, for example, from 0.01 to 10% by weight, preferably from 0.05 to 6% by weight and especially from 0.05 to 4% by weight, based on the total weight of the washing composition or fabric softener composition, preference being given in this case to liquid washing and fabric softener compositions.

The fixing agent can also be applied directly, for example by applying an aqueous solution, e.g. by means of a sponge or cloth or by spraying. The composition may also be applied in the form of a paste or a powder. Such a procedure is especially suitable when treating leather materials or surfaces composed of textile fibre materials.

According to a preferred embodiment, the fixing agent is used together with a bleaching agent.

Suitable bleaching agents are both liquid and solid bleaching agents. Suitable peroxide components include, for example, the organic and inorganic peroxides known in the literature and available commercially that bleach textile materials at conventional washing temperatures, for example at from 10 to 95° C.

The organic peroxides are, for example, mono- or poly-peroxides, especially organic peracids or salts thereof, such as phthalimidoperoxycaproic acid, peroxybenzoic acid, diperoxydodecanedioic acid, diperoxynonanedioic acid, diperoxydecanedioic acid, diperoxyphthalic acid or salts thereof.

Preference is given, however, to the use of inorganic peroxides, for example persulfates, perborates, percarbonates and/or persilicates. Mixtures of inorganic and/or organic peroxides may, of course, also be used. The peroxides may be in a variety of crystalline forms and may have different water contents, and they may also be used together with other inorganic or organic compounds to improve their storage stability.

Further bleach-activating active ingredients are known transition metal salts and complexes and/or conventional bleach activators; that is to say, compounds that, under perhydrolysis conditions, yield unsubstituted or substituted perbenzo- and/or peroxo-carboxylic acids having from 1 to 10 carbon atoms, especially from 2 to 4 carbon atoms. Suitable compounds include the afore-mentioned customary bleach activators that carry 0- and/or N-acyl groups having the said number of carbon atoms and/or unsubstituted or substituted benzoyl groups. Preference is given to polyacylated alkylenediamines, especially tetraacetylethylenediamine (TAED), acylated glycolurils, especially tetraacetylglycoluril (TAGU), N,N-diacetyl-N,N-dimethyl-urea (DDU), acylated triazine derivatives, especially 1,5-diacetyl-2,4-dioxohexa-hydro-1,3,5-triazine (DADHT), compounds of formula (2)

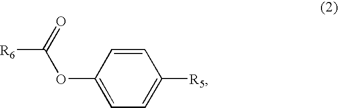

wherein R₅ is a sulfonate group, a carboxylic acid group or a carboxylate group, and wherein R₆ is linear or branched (C₇-C₁₅)alkyl; also activators that are known under the names SNOBS, SLOBS and DOBA, acylated polyhydric alcohols, especially triacetin, ethylene glycol diacetate and 2,5-diacetoxy-2,5-dihydrofuran and acetylated sorbitol and mannitol and acylated sugar derivatives, especially pentaacetylglucose (PAG), sucrose polyacetate (SUPA), pentaacetylfructose, tetraacetylxylose and octaacetyllactose, and acetylated, optionally N-alkylated, glucamine and gluconolactone. The combinations of conventional bleach activators disclosed in German Patent Application DE-A-44 43 177 may also be used. Nitrile compounds that form periminic acids with peroxides are also suitable as bleach activators. Sodium hypochlorite, Javelle water and hydrogen peroxide may also be mentioned.

The bleaching agents are preferably used as a further constituent of the liquid aqueous formulations of the dye-fixing agent that are mentioned hereinbefore. The definitions and preferred meanings mentioned hereinbefore apply to those liquid aqueous formulations; the definitions and preferred meanings mentioned hereinbefore apply to the dye-fixing agents. Also of special interest in that context are dye-fixing agents that have been completely or partially neutralised with acetic acid.

The concentration of bleaching agents therein can vary within wide limits and is preferably from 0.1 to 25% by weight, especially from 0.5 to 20% by weight and more especially from 0.5 to 10% by weight, based on the total weight of the formulation. As a lower limit, preference is given to an amount of 1% by weight, especially 2% by weight. In addition, it is of course also possible for the bleaching agent and the dye-fixing agent to be applied separately. Suitable application methods include those mentioned hereinbefore. Application may be carried out, for example, before the washing procedure, during or after the washing procedure, preferably during the washing procedure. A dye-fixing agent comprising a bleaching agent is preferably not a constituent of a washing or fabric softener composition.

Suitable textile fibre materials are, for example, hydroxy-group-containing and amino-group-containing fibre materials. Examples that may be mentioned include polyamide, wool and, especially, natural or regenerated cellulose.

The present invention relates also to washing formulations and fabric softener formulations for reducing dye loss or dye transfer from textile fibre materials or leather in the domestic sector which comprise the dye-fixing agent mentioned hereinbefore. The definitions and preferred meanings mentioned hereinbefore apply thereto.

The present invention further relates to dye-fixing agents based on basic polycondensation products of an amine of formula (1) and a cyanamide, which polycondensation products are completely or partially neutralised with an aliphatic C₁-C₁₂-mono- or-poly-carboxylic acid other than acetic acid. The definitions and preferred meanings mentioned hereinbefore apply thereto.

The materials treated in accordance with the method of the invention exhibit significantly reduced transfer of dye onto other materials, e.g. undyed materials or materials dyed in other or light shades, that effect being almost entirely retained even after several washes without renewed treatment. As a result, the colour shade of the dyed materials, moreover, remains largely unchanged even after several washes. If desired, the dye-fixing agents may also be formulated without the otherwise customary addition of surfactants, e.g. in the form of aqueous solutions, that being especially the case for treatment before or after washing. The presence of surfactants, which otherwise are often used for formulating the dye-fixing agents, is therefore unnecessary. Moreover, the dye-fixing agents can be combined surprisingly well with bleaching agents, which therefore enables them to be applied together with bleaching agents. Furthermore, the dye-fixing agents can be combined very well with commercially available washing and fabric softener compositions.

The Examples that follow illustrate the invention. Parts therein denote parts by weight, unless otherwise indicated.

### EXAMPLE 1

a) 206.4 parts of diethylenetriamine and 55.6 parts of ethylene glycol are introduced at room temperature into a reactor under an inert gas atmosphere and are heated to 120° C. under a gentle stream of nitrogen. 128 parts of ammonium chloride are then added in portions over the course of one hour so that the internal temperature remains at 118° C. After the addition is complete, the reaction mixture is heated to 160° C. and 218 parts of dicyandiamide are so added under inert conditions over the course of one hour that the internal temperature remains above 155° C. The mixture is then heated at from 180 to 210° C. and maintained at that temperature for about from 1 to 5 hours. Finally, 200 parts of deionised water are added over the course of about from 20 to 25 minutes, and 665 parts of a solution having a dry solids content of 70% are obtained.

b) 200 parts of a reaction mixture obtained according to a) are diluted with 80 parts of deionised water. At 90° C., 11.5 parts of phosphoric acid are added over the course of 10 minutes. After the addition is complete, the mixture is cooled to room temperature, with stirring. A clear, light-yellow liquid having a pH of 7.21 is obtained, which is adjusted with deionised water to a final concentration of 1% by weight of dye-fixing agent, based on the total weight of the solution.

### EXAMPLE 2

558.7 parts of a reaction mixture obtained according to Example 1a) are diluted with 206.6 parts of deionised water. At 50° C., 32.5 parts of acetic acid are added over the course of 12 minutes. After the addition is complete, the mixture is cooled to room temperature, with stirring. A clear, light-yellow liquid having a pH of 7.24 is obtained, which is adjusted with deionised water to a final concentration of 1% by weight of dye-fixing agent, based on the total weight of the solution.

### EXAMPLES 3 TO 11

By proceeding as described in Example 1 but using, instead of 11.5 parts of phosphoric acid, an appropriate amount of oxalic acid, propionic acid, succinic acid, maleic acid, gluconic acid, sulfuric acid, benzoic acid or acrylic acid required to adjust the pH to 7.2, analogous solutions are obtained.

### EXAMPLE 12

a) A cotton fabric dyed with the dye C.I. Direct Blue 78 is pre-treated in an aqueous bath containing 18 g/litre of the solution of fixing agent obtainable according to Example 1, at a temperature of 25° C. and a liquor ratio of 10:1 for 5 minutes. The cotton fabric is then wrung out, and dried at 60° C.

The cotton fabric pre-treated in that manner is washed together with a white, undyed cotton fabric using 10 g/litre of a standard washing composition (standard washing composition ECE phosphate-free (456 IEC) EMPA, Switzerland) at a temperature of 40° C. and a liquor ratio of 15:1 for 15 minutes. The cotton fabrics are then rinsed with tap water, wrung out, and dried at a temperature of 60° C.

b) The procedure is as described under a), but the dyed cotton fabric is not pre-treated with the dye-fixing agent.

The undyed cotton fabric obtained according to a) exhibits significantly less staining than the undyed cotton fabric obtained according to b).

### EXAMPLES 13 TO 22

By proceeding as described in Example 12 but using, instead of the solution of the dye-fixing agent according to Example 1, a solution according to one of Examples 2 to 11, analogous results are obtained.

### EXAMPLE 23

a) A cotton fabric dyed with the dye C.I. Direct Blue 78 is introduced together with a white, undyed cotton fabric into a washing bath containing 30 g of a liquid standard washing composition and 30 g of Formulation A (or B or C) described below per kg of cotton fabric and is washed at a temperature of 25° C. and in a liquor ratio of 10:1 for 20 minutes. The cotton fabric is then rinsed with tap water, wrung out, and dried at a temperature of 60° C.

b) Composition of the formulations used

| | Formulation A | Formulation B | Formulation C |
|---|---|---|---|
| Hydrogen peroxide | — | 6% by weight | 6% by weight |
| Dye-fixing agent | — | — | 2.5% by weight |
| Water (deionised) | to 100% by weight | to 100% by weight | to 100% by weight |
| pH | 5.2 | 5.2 | 5.3 |

Adjustment of the pH is in each case carried out using hydrochloric acid. A composition obtainable according to Example 2 is used as the dye-fixing agent, although it is adjusted with deionised water to a final concentration of 33% by weight of dye-fixing agent.

The undyed cotton fabric obtained according to a) exhibits significantly less staining when Formulation C is used than the undyed cotton fabric obtained when Formulation A or B is used.

Analogous results are obtained when, instead of a cotton fabric dyed with the dye C.I. Direct Blue 78, a cotton fabric dyed with the dye C.I. Direct Red 227, C.I. Direct Violet 66 or C.I. Direct Yellow 106 is used.

### EXAMPLE 24

a) The treatment that follows is carried out five times using the same dyed cotton fabric but for each new cycle a new undyed cotton fabric is used:

A cotton fabric dyed with the dye C.I. Direct Blue 78 is washed together with a white, undyed cotton fabric using 3.8 g/litre of a standard washing composition (standard washing composition ECE 77) at a temperature of 25° C. and in a liquor ratio of 40:1 (tap water) for 10 minutes, is then rinsed with tap water in a liquor ratio of 40:1 for 5 minutes and is then spun.

The cotton fabrics are then rinsed for 5 minutes at a temperature of 25° C. and in a liquor ratio of 40:1 using tap water and 2 g/litre of a commercially available fabric softener composition comprising, in addition, 1% by weight of the fixing agent solution obtainable according to Example 1. The cotton fabrics are then spun, and dried at a temperature of 60° C.

b) The procedure is as described under a), but no dye-fixing agent is used.

The undyed cotton fabric obtained according to a) exhibits, in all cases, significantly less staining than the corresponding undyed cotton fabric obtained according to b).

### EXAMPLE 25

a) A cotton fabric dyed with the dye C.I. Direct Blue 78 is pre-treated in an aqueous bath containing 2 g/litre (or 10 g/litre) of a commercially available fabric softener composition containing, in addition, 1% by weight of the fixing agent solution obtainable according to Example 1, at a temperature of 25° C. and in a liquor ratio of 40:1 for 5 minutes. The cotton fabric is then spun, and dried at a temperature of 60° C.

The treatment that follows is carried out five times using the same dyed cotton fabric but for each new cycle a new undyed cotton fabric is used:

The cotton fabric pre-treated as described above is washed together with a white, undyed cotton fabric using 3.8 g/litre of a standard washing composition (standard washing composition ECE 77) at a temperature of 25° C. and in a liquor ratio of 40:1 (tap water) for 10 minutes, is then rinsed with tap water in a liquor ratio of 40:1 for 5 minutes and is then spun. The cotton fabrics are then rinsed for 5 minutes at a temperature of 25° C. and in a liquor ratio of 40:1 using tap water and 2 g/litre of a commercially available fabric softener composition containing, in addition, 1% by weight of the fixing agent solution obtainable according to Example 1. The cotton fabrics are then spun, and dried at a temperature of 60° C.

b) The procedure is as described under a), but no dye-fixing agent is used.

The undyed cotton fabric obtained according to a) exhibits, in all cases, significantly less staining than the corresponding undyed cotton fabric obtained according to b).

### EXAMPLE 26

a) 5 g of a cotton fabric dyed with the dye C.I. Direct Blue 78 are washed together with 5 g of a white, undyed cotton fabric using 1.5 g/litre of a standard washing composition containing 1.65% by weight (or 3.3% or 13.3% by weight) of the fixing agent solution obtainable according to Example 1, at a temperature of 40° C. and in a liquor ratio of 15:1 (tap water) for 15 minutes and is then rinsed with tap water in a liquor ratio of 40:1 for 5 minutes. The cotton fabrics are then spun, and dried at a temperature of 60° C.

b) The procedure is as described under a), but no dye-fixing agent is used.

The undyed cotton fabric obtained according to a) exhibits, in all cases, significantly less staining than the corresponding undyed cotton fabric obtained according to b).

Formulation of the washing composition used:

7.5% by weight alkyl benzenesulfonate

17% by weight alkyl ether sulfate

12.5% by weight lauric acid

10% by weight Dobanol® 23-6.5 (non-ionic surfactant based on fatty alcohol ethoxylate)

5.5% by weight trisodium citrate

0.7% by weight alkyltrimethylammonium chloride

6.0% by weight ethanol

6.0% by weight isopropanol

5.2% by weight potassium hydroxide

the appropriate amount of dye-fixing agent mentioned above (0, 1.65, 3.3 or 13.3% by weight), and

an amount of water to make 100% by weight.

What is claimed is:

1. A method for reducing dye loss or dye transfer from textile fibre materials or leather in the domestic sector, which comprises treating the textile fibre materials or the leather with a dye-fixing agent based on basic polycondensation products of an amine of formula 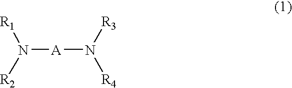
and a cyanamide, which polycondensation products are completely or partially neutralised with an inorganic or organic acid,
R₁, R₂, R₃ and R₄ each independently of the others being hydrogen or alkyl that is unsubstituted or substituted by amino, hydroxy, cyano or by C₁-C₄alkoxy and A being alkylene optionally substituted or interrupted by one or more hetero atoms.

2. A method according to claim 1, wherein A is C₂-C₂₀alkylene optionally interrupted by —O—, —S—, —NH— or by —N(C₁-C₄alkyl)- and/or substituted by hydroxy, especially C₂-C₂₀alkylene interrupted one or more times by —NH—.

3. A method according to either claim 1 or claim 2, wherein the compound of formula (1) is a polyethylenepolyamine, especially diethylenetriamine.

4. A method according to any one of claims 1 to 3, wherein the cyanamide is dicyandiamide.

5. A method according to any one of claims 1 to 4, wherein the inorganic or organic acid is a mono- or poly-carboxylic acid, hydrochloric acid, phosphoric acid, sulfuric acid or a mixture of at least two such acids.

6. A method according to claim 5, wherein the acid is an aliphatic C₁-C₁₂-mono- or -poly-carboxylic acid.

7. A method according to claim 5, wherein the acid is an aliphatic C₂-C₁₂polycarboxylic acid, especially an aliphatic C₂-C₆polycarboxylic acid.

8. A method according to claim 5, wherein the acid is a hydroxy-substituted aliphatic C₂-C₆polycarboxylic acid.

9. A method according to any one of claims 1 to 8, wherein the dye-fixing agent is used together with a bleaching agent.

10. A method according to claim 9, wherein a peroxide, especially hydrogen peroxide, is used as the bleaching agent.

11. A method according to any one of claims 1 to 10, wherein the method is carried out without surfactants being present.

12. A method according to any one of claims 1 to 11, wherein leather is treated.

13. A method according to any one of claims 1 to 11, wherein before the washing procedure textile fibre materials are pre-treated in an aqueous bath with the dye-fixing agent.

14. A method according to any one of claims 1 to 10, wherein during the washing procedure textile fibre materials are treated in an aqueous bath with the dye-fixing agent, together with a washing composition or as a constituent of a washing composition.

15. A method according to any one of claims 1 to 11, wherein after the washing procedure textile fibre materials are treated in an aqueous bath with the dye-fixing agent without a fabric softener composition being present.

16. A method according to any one of claims 1 to 10, wherein after the washing procedure textile fibre materials are treated in an aqueous bath with the dye-fixing agent, together with a fabric softener composition or as a constituent of a fabric softener composition.

17. A washing formulation for reducing dye loss or dye transfer from textile fibre materials or leather in the domestic sector, which comprises a dye-fixing agent based on basic polycondensation products of an amine of formula 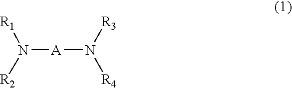
and a cyanamide, which polycondensation products are completely or partially neutralised with an inorganic or organic acid,
R₁, R₂, R₃ and R₄ each independently of the others being hydrogen or alkyl that is unsubstituted or substituted by amino, hydroxy, cyano or by C₁-C₄alkoxy and A being alkylene optionally substituted or interrupted by one or more hetero atoms.

18. A formulation according to claim 17, wherein the acid is an aliphatic C₁-C₁₂-mono- or -poly-carboxylic acid.

19. A formulation according to claim 17, wherein the acid is an aliphatic C₂-C₁₂polycarboxylic acid, especially an aliphatic C₂-C₆polycarboxylic acid

20. A formulation according to claim 17, wherein the acid is a hydroxy-substituted aliphatic C₂-C₆polycarboxylic acid.

21. A fabric softener formulation for reducing dye loss or dye transfer from textile fibre materials or leather in the domestic sector, which comprises a dye-fixing agent based on basic polycondensation products of an amine of formula 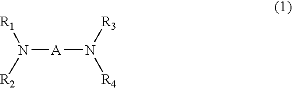
and a cyanamide, which polycondensation products are completely or partially neutralised with an inorganic or organic acid,
R₁, R₂, R₃ and R₄ each independently of the others being hydrogen or alkyl that is unsubstituted or substituted by amino, hydroxy, cyano or by C₁-C₄alkoxy and A being alkylene optionally substituted or interrupted by one or more hetero atoms.

22. A formulation according to claim 21, wherein the acid is an aliphatic C₁-C₁₂-mono- or -poly-carboxylic acid.

23. A formulation according to claim 21, wherein the acid is an aliphatic C₂-C₁₂polycarboxylic acid, especially an aliphatic C₂-C₆polycarboxylic acid.

24. A formulation according to claim 21, wherein the acid is a hydroxy-substituted aliphatic C₂-C₆-polycarboxylic acid.

25. A dye-fixing agent based on basic polycondensation products of an amine of formula 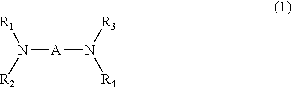
and a cyanamide, which polycondensation products are completely or partially neutralised with an aliphatic C₁-C₁₂ mono- or poly-carboxylic acid other than acetic acid, R₁, R₂, R₃ and R₄ each independently of the others being hydrogen or alkyl that is unsubstituted or substituted by amino, hydroxy, cyano or by C₁-C₄alkoxy and A being alkylene optionally substituted or interrupted by one or more hetero atoms.

26. A dye-fixing agent according to claim 25, wherein the acid is an aliphatic C₂-C₁₂polycarboxylic acid, especially an aliphatic C₂-C₆polycarboxylic acid.

27. A dye-fixing agent according to claim 25, wherein the acid is a hydroxy-substituted aliphatic C₂-C₆polycarboxylic acid.
